(19) United States
(12) Patent Application Publication
(10) Pub. No.: US 2011/0125184 A1
(43) Pub. Date: May 26, 2011

(54) Intraoral acupressure apparatus

(76) Inventor: James Peter Allen, Bend, OR (US)

(21) Appl. No.: 12/592,297

(22) Filed: Nov. 23, 2009

(51) Int. Cl. A61H 39/00

(52) U.S. Cl. 606/204

(57) ABSTRACT

An intraoral acupressure apparatus made from a model conforming to a user's palate, wherein the apparatus is adapted to be removably retained adjacent to the palate in a predetermined position, relative to acupressure points located on the palate of the user. Various means for securing the apparatus adjacent to the user's palate can be used and the apparatus has one or more projections embedded into the apparatus and extending out from the apparatus into the user's palate at one or more of the acupressure points. These projections into the palate of the user create and stimulate the pressure points that influence corresponding specific body functions to be treated.

### CROSS-REFERENCE TO RELATED APPLICATIONS

None

### STATEMENT REGARDING FEDERALLY SPONSORED RESEARCH OR DEVELOPMENT

None

### BACKGROUND OF THE INVENTION

The present invention relates to the acupressure treatment and more specifically to a method and apparatus for applying pressure and/or stimulation to intraoral sites to elicit a response directed toward habit control and/or weight loss. The apparatus can be used to elicit responses for smoking, weight loss, anxiety treatment or other responses from acupressure/acupuncture stimulation.

The prior art is replete with acupressure apparatuses. Some of the devices in the prior art are designed for specific locations of the human body while other acupressure devices are designed to be used at various locations on the human skin.

For example, US Pat. No. 4,073,296 issued to McCall discloses an acupressure device for the ear. There appears to be a several acupressure devices for the ear, including: U.S. Pat. No. 5,735,143 issued to Tanaka; and U.S. Pat. No. 4,319,574 issued to Sun. Other patents claim devices that are used on the human hand and provide a means of applying the stimulus to various parts of the body, including: U.S. Pat. No. 3,923,064 issued to Leupold; and U.S. Pat. No. 6,299,586 issued to Cao. And finally, other patents claim a device that can be applied to the skin of various areas on the body, including: U.S. Pat. No. 5,709,647 issued to Ferber; U.S. Pat. No. 5,792,176 issued to Chang; U.S. Pat. No. 5,250,067 issued to Gelfer, et al.

There is much discussion in the prior art on the efficacy of acupressure and the need for a device that is easy to use with little inconvenience for the user. The present invention is unique in locating the apparatus intraoral and more specifically delivering the acupressure or acupuncture stimulation to the palate of the user.

### BRIEF SUMMARY OF THE INVENTION

It has been shown that applying stimulation through a manner of acupressure/acupuncture to sites intraorally by using an intraoral appliance can elicit a response used in weight loss and/or habit control and be used to elicit physiological responses for smoking, weight loss, anxiety treatment or other responses from acupressure/acupuncture stimulation.

The present invention is an apparatus made to cover the palatal area or the upper mouth. The apparatus can be either a complete or partial covering of the palate. This appliance has projections that extend towards the palate into and onto the tissues to stimulate areas of acupressure/acupuncture stimulation. These projections can be fixed or adjustable. The adjustments to the projections would be to modify the depth, extension and place of acupressure/acupuncture stimulation.

The appliance can be held or retained by wires, clasps, suction, adhesives, cohesion and/or precision of fit. The fabrication of the appliance can be through direct methods in the mouth. The fabrication of the appliance can be through indirect methods. These indirect methods can be, but not limited to impressions, models, 3-D scans, radiology modeling, ultra-sound and or other techniques to render models and forms of the palate and other areas of the mouth. These models can be castings, plaster or digital models to be used in fabrication of these appliances.

These appliances can be fabricated using resins, polymers, metals, plastics or other rigid and flexible material and combinations of materials.

The projections from the palatal side of the appliance will vary in location, depth and shape. The location varies with patient anatomy and required area of acupressure/acupuncture stimulation.

### BRIEF DESCRIPTION OF THE SEVERAL VIEWS OF THE DRAWING

FIG. 1 is a side perspective view of the intraoral acupressure apparatus.

FIG. 2 is a top plan view of the intraoral acupressure apparatus with the projections located at spots corresponding to acupressure treatment areas.

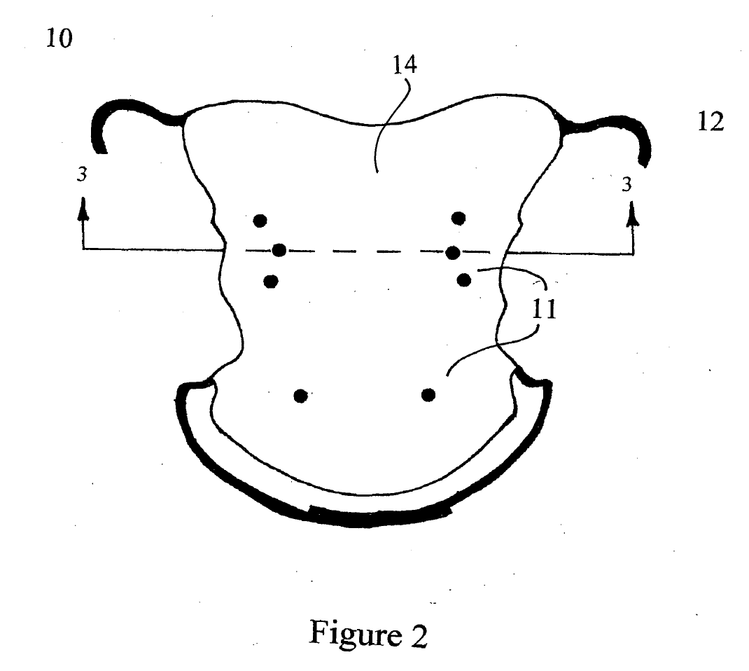

FIG. 3 is a sectional view of the intraoral acupressure apparatus taken along line 3-3 of FIG. 2.

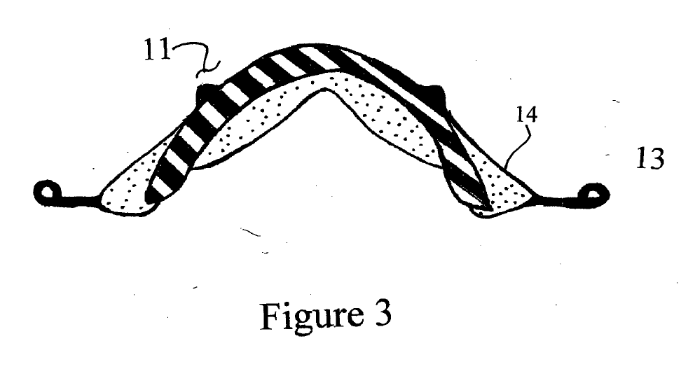

### DETAILED DESCRIPTION OF THE INVENTION

Various embodiments of the invention will now be described. The following descriptions provide specific details for a thorough understanding and enabling description of these embodiments. It should be noted, however, that the above “Background” describes technologies that may enable aspects and embodiments of the invention. One skilled in the relevant arts will understand, however, that the invention may be practiced without many of these details. Additionally, some well-known structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

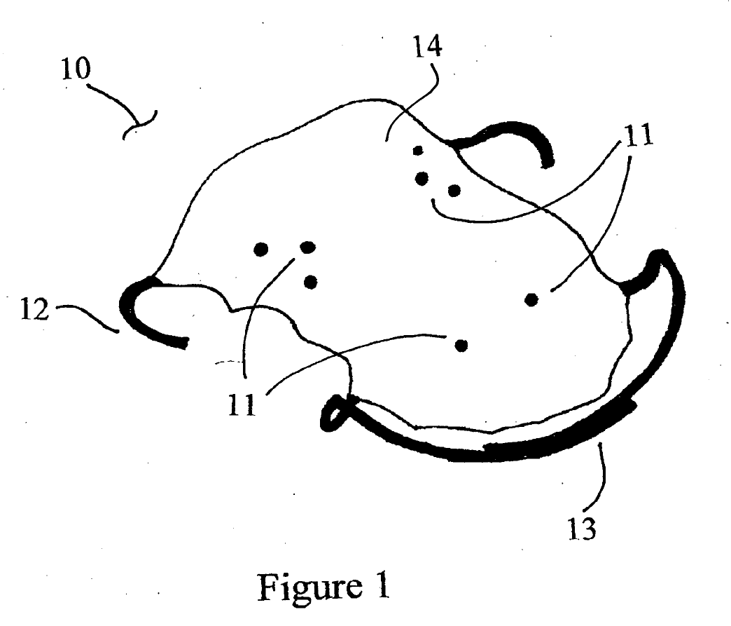

FIG. 1 is a perspective view of an intraoral acupressure apparatus 10 (apparatus) that can be formed to a particular user's palate. The palate apparatus 14 is initially made from an impression of the user's palate. The impression is typically made from one of many materials used in surgical or dental applications and can be made from any acceptable method for making a direct or indirect impression of the palate region of the mouth. The present invention does not make claims for making a new or novel impression and subsequent apparatus of a palate but is able to use the apparatus of a palate made from the various means for the present invention.

Once the impression of the user's palate has been made, an apparatus of the impression is created using any one of the various types of materials used in the manufacture of dental, orthodontic or medical devices, including but not limited to; plastics, polymers, resin or a combination of material to create a thin rigid yet somewhat flexible cast of the user's palate. After the apparatus has been made, acupressure points are located on the apparatus that will correspond to areas on the palate that are known to have areas that can be stimulated for acupressure treatment. These acupressure points will vary depending on the anatomy of the user. In one embodiment of the application, the acupressure points on the palate are located and marked with a surgical marking pen on the user's palate. The markings are transferred to the impression and then easily located on the palate apparatus 14. The projections 11 are then located on the palate apparatus 14. This type of locating on the human body and then using the marked spots for casts, molds, and other medical devices is well known in the art and is not a method being claimed in the present invention. The areas of acupressure are indicated intra orally and this information transferred to the final model.

Once the acupressure points have been located on the apparatus of the palate, projections 11 are added to the apparatus that extends out the top of the palate apparatus. The projections can have various shapes including but not limited to; bead, spherical, nodule, spike or pointed. The size of the projection can vary and can be adjusted. When the palate apparatus is worn by the user, the projections 11 extend into the soft tissue of the user's palate stimulating that region of the user's palate.

The palate apparatus 14 apparatus can be kept in place using various means known to those in the art of making orthodontic retainer or similar arts and it is not the purpose of this application to make claims regarding the means for securing the palate apparatus in place. In the figures, the palate apparatus is kept in place by adding wire hooks 12 and 13 to the palate apparatus that secures the apparatus to the user's palate. Other means for keeping the palate apparatus in place in the user's mouth are available, including; clasps, suction, adhesives, cohesion, and/or precision fit.

1. An intraoral acupressure apparatus comprising:
an apparatus conforming to a user's palate, said apparatus adapted to be removably retained adjacent to the palate in a predetermined position, relative to acupressure points located on the palate of the user;
a means for securing the apparatus adjacent to the user's palate; and
one or more projections embedded into the apparatus and extending out from the apparatus into the soft tissue of the user's palate at one or more of the acupressure points, wherein the one or more projections extending into the acupressure points influence corresponding specific body functions to be treated.

2. The intraoral acupressure apparatus of claim 1 wherein the projections can be shaped as one or more of the following; nodules, spherical, or pointed.

3. The intraoral acupressure apparatus of claim 1 wherein the apparatus can be made from one or more of the following; plastic, polymer, or resin.

4. The intraoral acupressure apparatus of claim 1 wherein the apparatus is made from a combination of materials for making a rigid apparatus of the user's palate.

5. The intraoral acupressure apparatus of claim 1 wherein the means for securing the apparatus adjacent to the user's palate can be one or a combination of the following; wire, clasps, suction, adhesives, cohesion, or precision fit.

6. A method of using an intraoral acupressure apparatus, including:
making a apparatus of a user's palate;
adding means for securing the apparatus adjacent to the user's palate wherein the apparatus is removably retained adjacent to the palate in a predetermined position relative to acupressure points located on the palate of the user; and
placing projections onto the surface of the apparatus such that when the apparatus is held adjacent to the palate of the user the projections are extending into the tissue of the user influencing specific body functions.

7. The method of using an intraoral acupressure apparatus of claim 6 wherein the projections can be shaped as one or more of the following; nodules, spherical, or pointed.

8. The method of using an intraoral acupressure apparatus of claim 6 wherein the apparatus can be made from one or more of the following; plastic, polymer, or resin.

9. The method of using an intraoral acupressure apparatus of claim 6 wherein the apparatus is made from a combination of materials for making a rigid apparatus of the user's palate.

10. The method of using an intraoral acupressure apparatus of claim 6 wherein the means for securing the apparatus adjacent to the user's palate is by wire.

11. The method of using an intraoral acupressure apparatus of claim 15 wherein the means for securing the apparatus adjacent to the user's palate can be one or a combination of the following; wire, clasps, suction, adhesives, cohesion, or precision fit.
